(19) United States
(12) Patent Application Publication
(10) Pub. No.: US 2005/0078563 A1
(43) Pub. Date: Apr. 14, 2005

(54) Read-out control for use with a domain expansion recording medium

(76) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/504,136

(22) PCT Filed: Jan. 24, 2003
(86) PCT No.: PCT/IB03/00223

(30) Foreign Application Priority Data
Feb. 14, 2002 (EP) 020755997

(51) Int. Cl. G11B 11/00

(52) U.S. Cl. 369/13.05

(57) ABSTRACT

The present invention relates to a method and apparatus for controlling a read-out operation from a magneto-optical recording medium, comprising a storage layer and a read-out layer, wherein an expanded domain leading to a reading pulse is generated in the read-out layer by copying a mark region from the storage layer to the read-out layer upon heating by a radiation power and with the aid of the external magnetic field. A switching time of the external magnetic field is derived from the reading pulse and a space run-length is determined on the basis of a time delay between the switching time and the reading pulse. The delay time need not have a fixed period such that space increments smaller than the channel bit length can be used for space run length coding. This results in a significantly improved resolution.

The present invention relates to a method, apparatus and record carrier for controlling read-out from a magneto-optical recording medium, such as a MAMMOS (Magnetic AMplifying Magneto-Optical System) disk, comprising a recording or storage layer and an expansion or read-out layer.

In magneto-optical storage systems, the minimum width of the recorded marks is determined by the diffraction limit, that is by the Numerical Aperture (NA) of the focussing lens and the laser wavelength. A reduction of the width is generally based on shorter wavelength lasers and higher NA focussing optics. During magneto-optical recording, the minimum bit length can be reduced to below the optical diffraction limit by using Laser Pulsed Magnetic Field Modulation (LP-MFM). In LP-MFM, the bit transitions are determined by the switching of the field and the temperature gradient induced by the switching of the laser. For read-out of the small crescent-shaped marks recorded in this way, Magnetic Super Resolution (MSR) or Domain Expansion (DomEx) methods have been proposed. These technologies are based on recording media with several magneto-static or exchange-coupled RE-TM layers. According to MSR, a read-out layer on a magneto-optical disk is arranged to mask adjacent bits during reading, while, according to domain expansion, a domain in the center of a spot is expanded. The advantage of the domain expansion technique over MSR results in that bits with a length below the diffraction limit can be detected with a similar signal-to-noise ratio (SNR) as bits with a size comparable to the diffraction limited spot. MAMMOS is a domain expansion method based on magneto-statically coupled storage and read-out layers, wherein a magnetic field modulation is used for expansion and collapse of expanded domains in the read-out layer.

In the above-mentioned domain expansion techniques, like MAMMOS, a written mark from the storage layer is copied to the read-out layer upon laser heating with the aid of an external magnetic field. Due to the low coercivity of this read-out layer, the copied mark will expand to fill the optical spot and can be detected with a saturated signal level which is independent of the mark size. Reversal of the external magnetic field collapses the expanded domain. A space in the storage layer, on the other hand, will not be copied and no expansion occurs. Therefore, no signal will be detected in this case.

The laser power used in the read-out process should be high enough to enable copying. On the other hand, a higher laser power also increases the overlap of the temperature-induced coercivity profile and the stray field profile of the bit pattern. The coercivity H_{c} decreases and the stray field increases with increasing temperature. When this overlap becomes too large, correct read-out of a space is no longer possible due to false signals generated by neighboring marks. The difference between this maximum and the minimum laser power determines the power margin, which decreases strongly with decreasing bit length. Experiments have shown that with the current methods, bit lengths of 0.10 μm can be correctly detected, but at a power margin of virtually nothing (1 bit of a 16 bit DAC). Thus, for highest densities the power margin remains quite small so that optical power control during read-out is essential.

In conventional MAMMOS read-out, the external magnetic field is modulated with a period corresponding to the size of a channel bit. Thus, a bit decision is made for each channel bit (mark or space, i.e. up or down magnetization). However, synchronization of the external field modulation with the bit pattern on the disc is critical. For example, when the copy window is close to its maximum size for correct read-out, a small phase error already introduces a false peak. For this synchronization, timing fields and/or a wobble in the track can be used. In this way, quite reasonable frequency control is possible, but phase errors are very difficult to avoid.

It is an object of the present invention to provide a method, apparatus and record carrier for domain expansion read-out control with improved synchronization and resolution or storage density.

This object is achieved by a method as claimed in claim 1 or 14, by an apparatus as claimed in claim 6 or 15, and by a record carrier as claimed in claim 12.

Accordingly, the delay time determined does not have a fixed period such that space increments smaller than the channel bit length can be used for space run-length coding. This results in a significantly improved resolution without additional demands on the field coil of the magnetic head and its driver.

Preferably, the time delay is measured between a field reversal to the expansion direction and the rising edge of said reading pulse.

A pulse correction has to be performed in a mark run-length detection based on said reading pulse. Thus, decoding errors due to additional false peaks achieved in the data-dependent field switching can be prevented.

The deriving means may be arranged to derive said switching time from a detected rising edge of said reading pulse. Then, the deriving means may be arranged to set the time period between the detection and the switching time in accordance with a channel bit period of said mark region.

The determination means may comprise a timer means for counting the time delay. Additionally, the determination means may be arranged to determine a shift in the switching time.

Other advantageous further developments are defined in the dependent claims.

The present invention will be described hereinafter on the basis of a preferred embodiment and with reference to the accompanying drawings, in which:

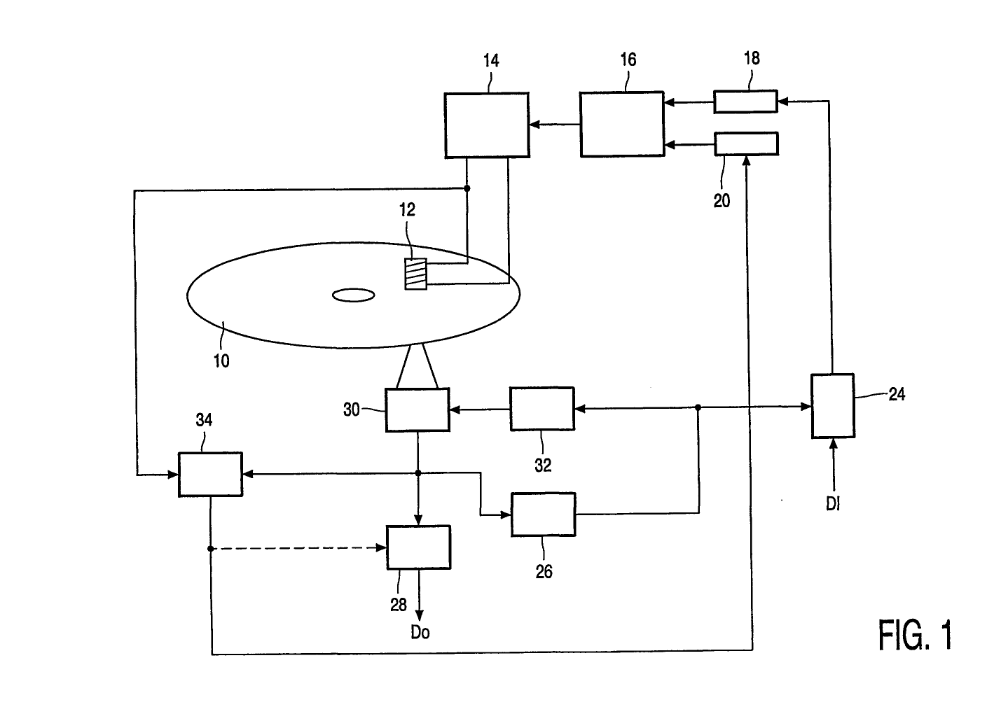

FIG. 1 shows a diagram of a magneto-optical disk player according to a preferred embodiment,

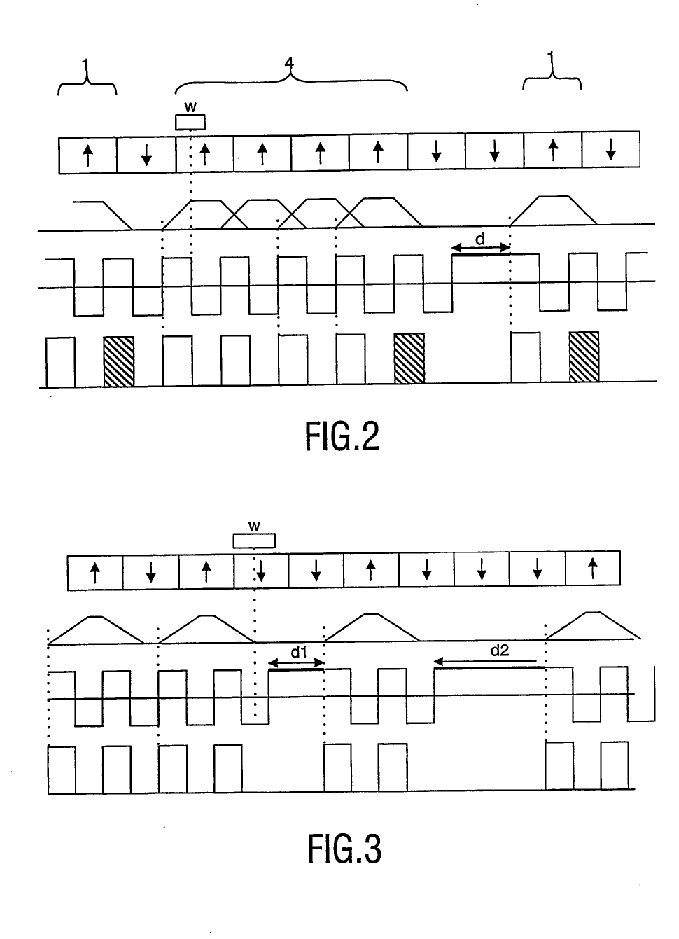

FIG. 2 shows read-out waveforms for a copy window size equal to half of the channel bit length,

FIG. 3 shows read-out waveforms for a copy window size between half of and a full channel bit length,

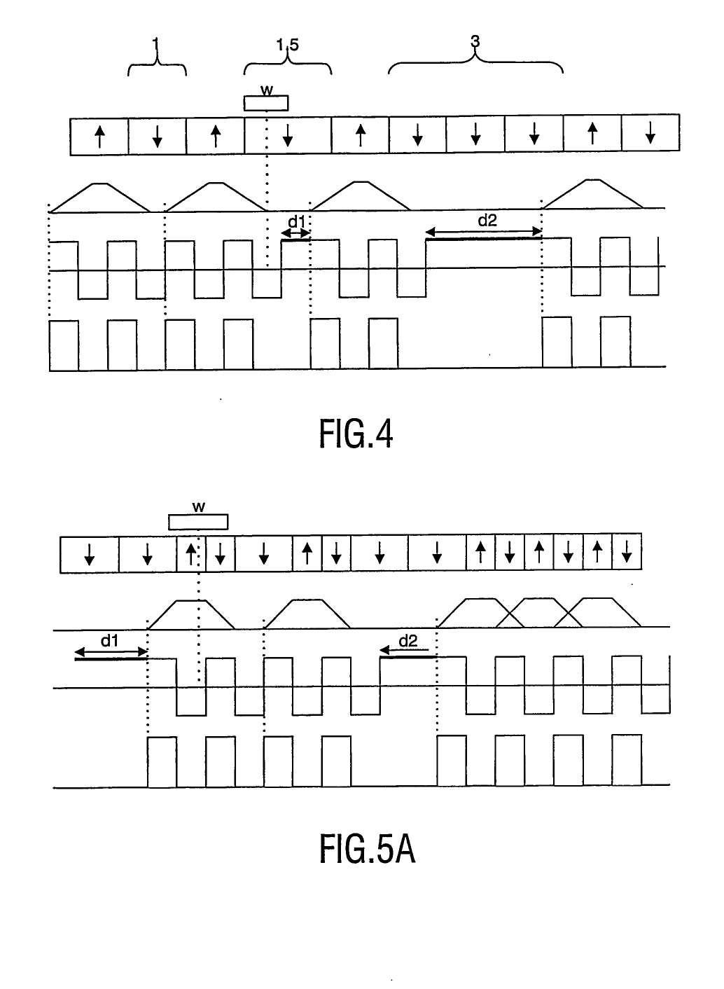

FIG. 4 shows read-out waveforms for a fractional increase in space run-lengths,

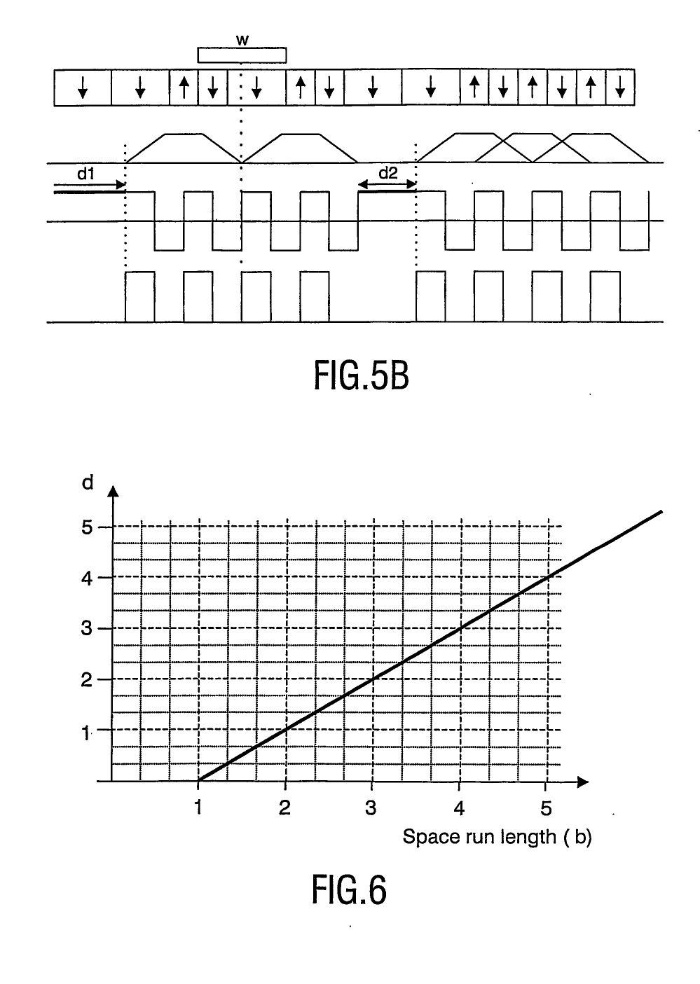

FIGS. 5A and 5B show read-out waveforms for a 50% write strategy at different copy window sizes, and

FIG. 6 shows a diagram indicating a characteristic of a MAMMOS peak delay as a function of the space run-length.

The preferred embodiment will now be described on the basis of a MAMMOS disk player as indicated in FIG. 1.

FIG. 1 schematically shows the construction of the disk player according to the preferred embodiments. The disk player comprises an optical pick-up unit 30 having a laser light radiating section for irradiation of a magneto-optical recording medium or record carrier 10, such as a magneto-optical disk, with light that has been converted, during recording, to pulses with a period synchronized with code data, and a magnetic field applying section comprising a magnetic head 12 which applies a magnetic field in a controlled manner at the time of recording and playback on the magneto-optical disk 10. In the optical pick-up unit 30 a laser is connected to a laser driving circuit which receives recording and read-out pulses from a recording/read-out pulse adjusting unit 32 to thereby control the pulse amplitude and timing of the laser of the optical pick-up unit 30 during a recording and read-out operation. The recording/read-out pulse adjusting circuit 32 receives a clock signal from a clock generator 26 which may comprise a PLL (Phase Locked Loop) circuit.

It is to be noted that for reasons of simplicity the magnetic head 12 and the optical pick-up unit 30 are shown on opposite sides of the disk 10 in FIG. 1. However, according to the preferred embodiment, they should be arranged on the same side of the disk 10.

The magnetic head 12 is connected to a head driver unit 14 and receives, at the time of recording, code-converted data via a phase adjusting circuit 18 from a modulator 24. The modulator 24 converts input recording data to a prescribed code.

At the time of playback, the head driver 14 receives a timing-signal via a playback adjusting circuit 20 from a timing circuit 34, the playback adjusting circuit 20 generating a synchronization signal for adjusting the timing and amplitude of pulses applied to the magnetic head 12. The timing circuit 34 derives its timing signal from the data read-out operation, as described later. Thus, data-dependent field switching can be achieved. A recording/playback switch 16 is provided for switching or selecting the respective signal to be applied to the head driver 14 at the time of recording and at the time of playback.

Furthermore, the optical pick-up unit 30 comprises a detector for detecting laser light reflected from the disk 10 and for generating a corresponding reading signal applied to a decoder 28 which is arranged to decode the reading signal to generate output data. Furthermore, the reading signal generated by the optical pick-up unit 30 is applied to a clock generator 26 in which a clock signal obtained from embossed clock marks of the disk 10 is extracted, and which applies the clock signal for synchronization purposes to the recording pulse adjusting circuit 32 and the modulator 24. In particular, a data channel clock may be generated in the PLL circuit of the clock generator 26. It is to be noted that the clock signal obtained from the clock generator 26 may as well be applied to the playback adjusting circuit 20 to thereby provide a reference or fallback synchronization which may support the data dependent switching or synchronization controlled by the timing circuit 34.

In the case of data recording, the laser of the optical pick-up unit 30 is modulated with a fixed frequency, corresponding to the period of the data channel clock, and the data recording area or spot of the rotating disk 10 is locally heated at equal distances. Additionally, the data channel clock output by the clock generator 26 controls the modulator 24 to generate a data signal with the standard clock period. The recording data are modulated and code-converted by the modulator 24 to obtain binary run-length information corresponding to the information of the recording data.

The structure of the magneto-optical recording medium 10 may, for example, correspond to the structure described in the JP-A-2000-260079.

In the preferred embodiment shown in FIG. 1, the timing circuit 34 is provided for applying a data-dependent timing signal to the playback adjusting circuit 20. As an alternative, the data-dependent switching of the external magnetic field may as well be achieved by applying the timing signal to the head driver 14 so as to adjust the timing or phase of the external magnetic field.

According to the preferred embodiment, timing information is obtained from the (user) data on the disc 10. To achieve this, the playback adjusting circuit 20 or the head driver 14 are adapted to provide an external magnetic field which extends normally in the expansion direction. When a rising signal edge of a MAMMOS peak is observed by the timing circuit 34 at an input line connected to the output of the optical pick-up unit 30, the timing signal is applied to the playback adjusting circuit 20 such that the head driver 14 is controlled to reverse the magnetic field after a short time so as to collapse the expanded domain in the read-out layer and shortly after that reset the magnetic field to the expansion direction. The total time between the peak detection and the field reset is set by the timing circuit 34 to correspond to one channel bit length on the disk 10 (times the linear disc velocity).

With the data-dependent field switching method mentioned above, synchronization is no longer required during read-out as the switching time is derived directly from the data. Moreover, the derived switching times can be used to further advantage as input for the PLL circuit of the clock generator 26 to provide an accurate data clock. More precise data recovery, based on the space run-length information in the time delay, can thus be obtained.

FIGS. 2 to 5B each show diagrams indicating from top to bottom a storage layer with its mark and space regions (indicated by upward and downward arrows, respectively) and with a copy window size w indicating the spatial width of the copy operation, and waveforms of an overlap signal, the alternating external magnetic field and the MAMMOS read-out signal, respectively. The overlap signal indicates a time-dependent value of the overlap between the coercivity profile and the stray field, which leads to a MAMMOS signal or peak when an external magnetic field is applied. In particular, a MAMMOS peak will be generated during the time period of the positive external magnetic field. Due to the fact that the overlap signal may extend until a neighboring (previous or next) positive period of the external magnetic field, additional peaks can be generated in the MAMMOS signal.

In FIG. 2, each mark run-length (indicated by upward arrows) will give one more MAMMOS peak (hatched) than its length divided by the channel bit length b which corresponds to one section in the schematically shown storage layer. Thus, an I1 mark run-length (length b) will give two peaks instead of one, an I2 mark run-length (length 2b) will give three peaks instead of two, etc. A comparison with FIG. 3, where corresponding waveforms are illustrated for a larger size w of the copy window, reveals that this situation remains valid for 0w<b. Thus, a corresponding correction algorithm has to be applied in the decoder 28 to obtain the mark run-length and hence the correct output data DO.

The space run-lengths in this scheme are derived from the time that the magnetic field extends in the expansion direction (positive values) before the next MAMMOS peak appears. These times d, d1, d2 are indicated in the FIGS. 2 to 5B. When a rising signal edge of the magnetic field is observed by the timing circuit 34, for example, on the basis of the output signal of the head driver 14, a timer circuit or timer function provided in the timing circuit 34 is started which counts the time until a rising signal edge of the next MAMMOS peak is detected at the output of the optical pick-up circuit 30.

It will be clear that a space run-length equal to the channel bit length b has no delay (no bold line) so that it cannot be detected. In FIG. 2, a delay d corresponding to an −I2 space run length (length 2b, “−” indicates a space) is indicated.

In FIG. 3, delays d1 and d2 corresponding to a −I2 and a −I3 space run-length, respectively, are indicated for a larger copy window size w. Furthermore, in FIG. 4, delays d1 and d2 are shown for a fractionally increased −I1.5 space run-length and a −I3 space run-length at the same copy window size w used in FIG. 3.

FIG. 6 shows a diagram indicating a characteristic curve of the peak delay d as a function of the space run-length SRL. From the FIGS. 3 and 4 it can be gathered that the delay determined at the timing circuit 34 is a smooth function of the space run-length. Therefore, there is no reason to increment space run-lengths by b (indicated by dashed grid lines in FIG. 6) as in the case of mark run-lengths. If the jitter in the read-out signal is small enough, increments (much) smaller than b (dotted grid lines in FIG. 6) can be used, for example, in the modulator 24, thus significantly increasing the storage density. The delay d determined can be applied from the timing circuit 34 to the decoder 28 such that a correct or precise decoding function for the space run-lengths can be achieved.

Furthermore, an improved write strategy may be necessary to avoid missing peaks in long mark run-lengths; it is also useful to increase the storage density and/or the power margin. In particular each mark channel bit (length b) may be composed of a small mark and a small space (total length b, mark portion as small as possible) as is illustrated in FIG. 5A. This effectively reduces the overlap and thus allows larger values of the copy window size w. For a 50% write strategy (length of a mark portion equals. the length of a space portion within the composed mark region), as is sketched in FIGS. 5A and 5B, the maximum copy window size w is 1.5b instead of b (to keep one additional peak per mark run-length, the minimum copy window size w becomes b/2). A larger copy window is very advantageous as this reduces the demands on the laser power control (or allows higher densities).

The invention offers a solution also if the power control that can be attained in the recording system is not sufficient and larger copy windows are required. In that case the minimum space run-length will have to be increased. For example, a space run-length larger than 2b will allow a maximum window of 2b for conventional writing and a window of 2.5b for a 50% write strategy. The storage density will now decrease due to a reduction of the code rate. The minimum mark run-length can remain at b, that is, an I1 mark run-length can be used.

The present invention can be applied to any reading system for domain expansion magneto-optical disk storage systems. Any waveform characteristic of the read-out signal, which indicates a change in the read-out signal, can be used in the analysis. The function of the timing circuit 34 may be provided by a discrete hardware unit or, alternatively, by a corresponding control program controlling a more general processing unit. The preferred embodiments may thus vary within the scope of the attached claims.

1. A method of controlling a read-out operation from a magneto-optical recording medium (10), said recording medium comprising a storage layer and a read-out layer, wherein an expanded domain leading to a reading pulse is generated in said read-out layer by copying a mark region from said storage layer to said read-out layer upon heating by a radiation power and with the aid of an external magnetic field, said method comprising
a step for deriving a switching time of said external magnetic field from said reading pulse, and
a determination step for determining a space run-length on the basis of a time delay between said switching time and said reading pulse.

2. A method according to claim 1, wherein said time delay is the time between a field reversal to the expansion direction and the rising edge of said reading pulse.

3. A method according to claim 1, wherein the time period from said reading pulse to a reset of said external magnetic field is set to correspond to one channel bit length.

4. A method according to claim 1, wherein a pulse correction is performed in a mark run length detection based on said reading pulse.

5. A method according to claim 1, wherein space increments smaller than a channel bit length are detected in said determination step.

6. A reading apparatus for controlling a read-out operation from a magneto-optical recording medium (10), said recording medium comprising a storage layer and a read-out layer, wherein an expanded domain leading to a reading pulse is generated in said read-out layer by copying a mark region from said storage layer to said read-out layer upon heating by a radiation power and with the aid of an external magnetic field, said apparatus comprising
deriving means (34, 20) for deriving a switching time of said external magnetic field from said reading pulse, and
determination means (34) for determining a space run length based on a time delay between said switching time and said reading pulse.

7. A reading apparatus according to claim 6, wherein said deriving means (34, 20) is arranged to derive said switching time from a detected rising edge of said reading pulse.

8. A reading apparatus according to claim 6, wherein said deriving means (34, 20) is arranged to set the time period between said detection and said switching time in accordance with a channel bit period of said mark region.

9. A reading apparatus according to claim 6, wherein said determination means (34) comprises a timer means for counting said time delay.

10. A reading apparatus according to claim 6, wherein said determination means (34) is arranged to determine a shift in said switching time, and to apply the result of said determination to a copy window control means (30).

11. An apparatus according to claim 6, wherein said reading apparatus is a disk player for MAMMOS disks.

12. A magneto-optical record carrier comprising a storage layer and a read-out layer, wherein an expanded domain leading to a pulse in a reading signal is generated in said read-out layer by copying a mark region from said storage layer to said read-out layer upon radiation heating and with aid of an external magnetic field, said record carrier (10) comprising space increments smaller than a channel bit length of said mark region.

13. A record carrier according to claim 12, wherein said record carrier is a MAMMOS disk (10).

14. A recording method for recording information on a magneto-optical recording medium (10), said recording medium comprising a storage layer and a read-out layer, said method comprising the steps of
recording said information by modulating run lengths of mark and space regions in said storage layer, and
performing said run length modulation of space regions by using increments smaller than a channel bit length of said mark regions.

15. A recording apparatus for recording information on a magneto-optical recording medium (10), said recording medium comprising a storage layer and a read-out layer, said apparatus comprising
recording means (12, 30) for recording said information by modulating run lengths of mark and space regions in said storage layer, and
means (24) for performing said run length modulation of space regions by using increments smaller than a channel bit length of said mark regions.
